(19) United States
(12) Patent Application Publication
(10) Pub. No.: US 2010/0175806 A1
(43) Pub. Date: Jul. 15, 2010

(54) Method for filling conductive paste and method for manufacturing multilayer board

(75) Inventors: Yoshihiko Shiraishi, Nagoya-city (JP); Yoshitarou Yazaki, Anjo-city (JP); Kazuo Tada, Anjo-city (JP); Susumu Honda, Toyoake-city (JP); Kouji Kondoh, Toyohashi-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/654,229

(22) Filed: Dec. 15, 2009

(30) Foreign Application Priority Data
Jan. 9, 2009 (JP) 2009-003826

(51) Int. Cl. B05D 5/12; B31B 1/60

(52) U.S. Cl. 156/60; 427/123

(57) ABSTRACT

In order to fill conductive paste including metal particles in a via hole formed in a film having a surface made of thermoplastic resin, mirror finish is performed with respect to the surface of the film so that surface roughness of the film becomes smaller than a minimum particle diameter of the metal particles included in the conductive paste. Thus, even when the conductive paste is directly put on the surface of the film and is moved on the surface of the film by using a squeegee, most of the metal particles do not remain on the surface of the film.

### CROSS REFERENCE TO RELATED APPLICATION

The present application is based on Japanese Patent Application No. 2009-003826 filed on Jan. 9, 2009, the disclosure of which is incorporated herein by reference.

### FIELD OF THE INVENTION

The present invention relates to a method for filling conductive paste including metal particles in a via hole formed in a substrate having a surface made of thermoplastic resin. Further, the present invention relates to a method for manufacturing a multilayer board by using the substrate in which the conductive paste is filled.

### BACKGROUND OF THE INVENTION

JP-A-2001-024323 corresponding to U.S. Pat. No. 6,889,433 describes a conventional multilayer printed circuit board. According to JP-A-2001-024323, conductive paste, which is obtained by mixing conductive metal particles with conductive filler and resin particles into a solvent and stirring the solvent, is filled in a via hole formed in a resin film as an insulating layer, and an interlayer connection with an adjacent wiring layer (e.g., circuit pattern layer) is performed by using the conductive paste.

A protection film is attached to a surface of the resin film, which is a side of a conductive-paste filling opening of the via hole, such that the conductive paste does not adhere to the surface of the resin film other than the via hole when the conductive paste is filled in the via hole. In order to form the via hole in the resin film having the protection film thereon, the resin film is irradiated with a laser beam from a side of the protection film, for example. By the laser beam irradiation, a hole having a bottom is formed. The bottom of the hole corresponds to the circuit pattern layer formed on a surface of the resin film, which is opposite from the surface to which the protection film is attached. The conductive paste is filled in the hole, which is used for the via hole, and then, the protection film is peeled from the resin film. In this manner, the resin film having the via hole filled with the conductive paste is obtained.

As described in JP-A-2001-024323, if a protection film is used when conductive paste is filled in a via hole, manufacturing cost may be increased because of various factors. For example, because a protection film is necessary for each of resin films, which function as insulating layers in a multilayer board, material cost for the protection film is very expensive. Further, because processes for attaching and peeling the protection film are necessary, manufacturing processes are increased, and thereby manufacturing cost is increased.

### SUMMARY OF THE INVENTION

In view of the above points, it is an object of the present invention to provide a method for filling conductive paste and a method for manufacturing a multilayer board. According to the methods, adhesion of metal particles of the conductive paste to a surface of a resin film can be prevented without using a protection film.

According to one aspect of the present invention, a method for filling a conductive paste including metal particles in a via hole formed in a substrate having a surface made of thermoplastic resin, includes performing mirror finish with respect to the surface of the substrate such that surface roughness of the substrate is smaller than a minimum particle diameter of the metal particles, putting the conductive paste directly on the surface of the substrate after the performing the mirror finish, and filling the conductive paste in the via hole by moving the conductive paste on the surface of the substrate with a squeegee having an end portion configured to be in close contact with the surface of the substrate.

In the configuration, the conductive paste can be filled in the via hole without using a protection film, and thereby, manufacturing cost can be reduced significantly.

### BRIEF DESCRIPTION OF THE DRAWINGS

The above and other objects, features and advantages of the present invention will become more apparent from the following detailed description made with reference to the accompanying drawings. In the drawings:

FIGS. 1A to 1F are cross-sectional views showing each of processes for manufacturing a multilayer board;

FIGS. 2A to 2D are cross-sectional views showing a conductive paste filing process and a metal particle removing process; and

FIGS. 3A to 3D are cross-sectional views showing a state that the conductive paste filling process and the metal particle removing process are performed with respect to a thermoplastic resin film, to which mirror finish is not performed.

### DETAILED DESCRIPTION OF THE PREFERRED EMBODIMENTS

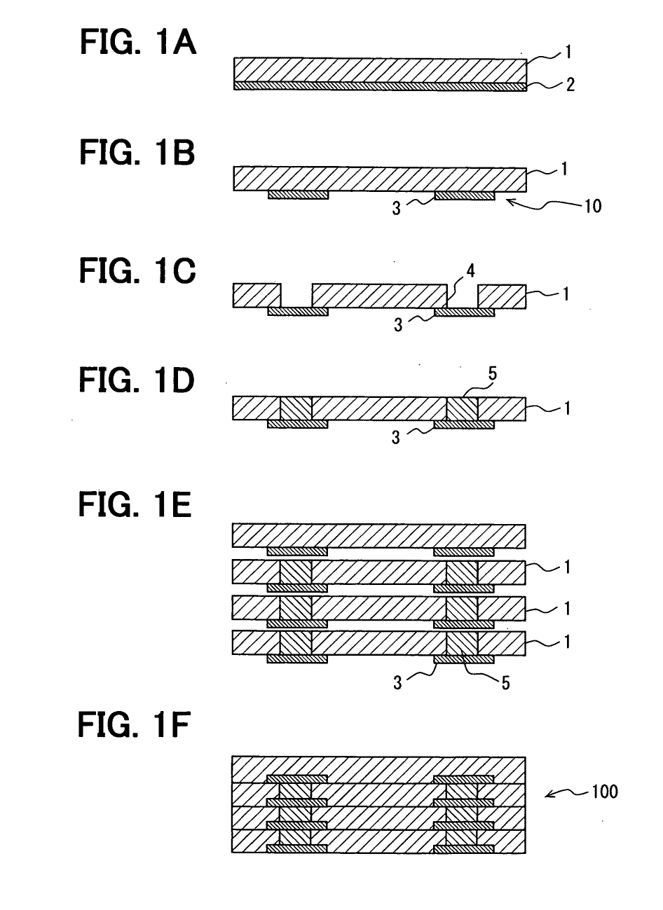

Hereinafter, a method for filling conductive paste and a method for manufacturing a multilayer board will be described based on an embodiment of the present invention. FIGS. 1A to 1F are cross-sectional views showing each of processes for manufacturing a multilayer board.

As shown in FIG. 1A, a film obtained by attaching a conductive metal layer 2 to one surface of a resin film 1 as an insulating substrate is prepared. The resin film 1 is a thermoplastic resin film made of 85% to 15% by weight of polyetheretherketone (PEEK) resin and 15% to 85% by weight of polyetherimide (PEI) resin, and a thickness thereof is 25 μm to 75 μm, for example. The metal layer 2 is made of a Copper foil having a thickness of 18 μm, for example.

The thermoplastic resin film 1 made of PEEK resin and PEI resin usually has minute irregularities on a surface thereof. Thus, if surface roughness of the thermoplastic resin film 1 is determined by ten points average height Rz specified in JIS, the ten points average height Rz becomes about 5 μm, for example. The ten points average height Rz is determined as follows. In a roughness curve in the range of an evaluation length, a sum of an average height of the five highest peaks from a mean line and an average depth of the five deepest valleys from the mean line is calculated, and the calculated value is expressed in micrometers.

In the present embodiment, by performing mirror finish with respect to the thermoplastic resin film 1 having such ten points average height Rz, the surface roughness of the thermoplastic resin film 1 is decreased. Specifically, the thermoplastic resin film 1 having the metal layer 2 thereon is heated under pressure by a mirror-finished metal plate (e.g., SUS plate). For example, a heating temperature is 200° C. or more, a pressure is 7 MPa or more, and a heat pressing time is 20 minutes or more.

By performing the heat-press in such conditions, the thermoplastic resin film 1 can be pressure-deformed at a temperature of decreasing viscoelasticity of the thermoplastic resin film. Thus, the mirror finish can be performed with respect to the thermoplastic resin film 1 by using the mirror-finished metal plate. Preferably, the ten points average height Rz of the surface of the thermoplastic resin film 1 after performing the mirror finish is at least 1 μm or less, and more preferably, about 0.5 μm.

Next, a circuit pattern 3 constructed of a conductor is formed on the surface of the resin film 1 (circuit pattern forming process). The circuit pattern forming process can be performed by etching, printing, vapor deposition, plating or the like. However, in the present embodiment, as shown in FIG. 1B, the metal layer 2 on the resin film 1 is etched to form the desired circuit pattern 3 and a circuit pattern layer (e.g., wiring layer) 10 is formed on one surface of the resin film 1.

Next, as shown in FIG. 1C, the resin film 1 is irradiated with a carbon dioxide laser from a surface thereof, on which the circuit pattern layer 10 is not formed, so that multiple via holes 4 are formed in the resin film 1 (via hole forming process). Each of the via holes 4 has a bottom, and the circuit pattern 3 is used as the bottom. An opening diameter of each of the via holes 4 is about 100 μm to 150 μm, for example.

The circuit pattern 3 that is the bottom of the via hole 4 is used as an electrode for an interlayer connection when multiple resin films 1 are stacked. In forming the via holes 4, output, irradiation time and the like of the carbon dioxide laser are appropriately controlled such that holes are not formed in the circuit pattern 3.

In forming the via holes 4, an excimer laser or the like can be used other than the carbon dioxide laser. Although the via holes 4 also can be formed with a drill, it is preferable that the via holes 4 are formed by a laser because a hole having a fine diameter can be formed and the circuit pattern 3 is not damaged at all.

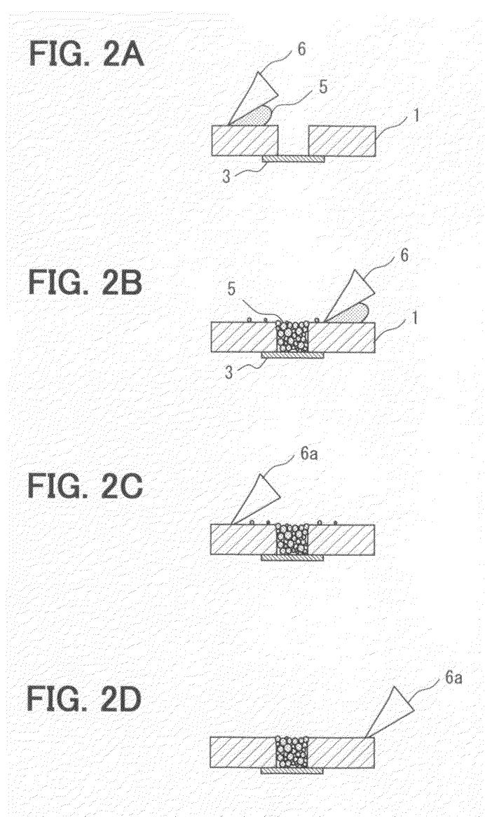

Next, as shown in FIG. 1D, conductive paste 5 is filled in each of the via holes 4 (conductive paste filling process). The conductive paste filling process will be described in detail with reference to FIGS. 2A to 2D.

The conductive paste 5 is made by mixing silver particles and tin particles into a solvent such as terpineol. The silver particles and the tin particles, are coated with a dispersing agent made of fatty acid (for example, stearic acid) so as to prevent the particles from aggregating. Thus, the silver particles and the tin particles are uniformly dispersed.

Particle diameters of metal particles including the silver particles and the tin particles vary in the range of about 0.1 μm to 10 μm. In the present embodiment, the metal particles having particle diameters of 1 μm or more are sorted by using a classifier, and the conductive paste 5 is made by using only the sorted metal particles. Further, each of the metal particles is coated with the dispersing agent. Thus, the actual particle diameter of the metal particle is dependent on the diameter of the metal particle and a thickness of the coated dispersing agent.

Metal particles used for common conductive paste include the metal particles having the particle diameters of 1 μm or more, and the metal particles can be used in the present embodiment. The conductive paste 5 is made by using the metal particles having the particle diameters of 1 μm or more so that a space between adjacent metal particles is not excessively enlarged when the conductive paste 5 is filled in the via hole 4. Thus, reliability of an interlayer connection can be increased and resistance can be decreased.

As shown in FIG. 2A, the conductive paste 5 is directly put on the thermoplastic resin film 1. Then, as shown in FIG. 2B, the conductive paste 5 is moved on the surface of the thermoplastic resin film 1 by using a squeegee 6 and is filled in the via hole 4. The squeegee 6 is made of a flexible material such as polyurethane rubber and is configured such that an end portion thereof is in close contact with the surface of the thermoplastic resin film 1.

In the present embodiment, the mirror finish is performed with respect to the surface of the thermoplastic resin film 1, and the surface roughness is smaller than a minimum particle diameter of the metal particles in the conductive paste 5. Hence, when the conductive paste 5 is moved on the thermoplastic resin film 1, most of the metal particles are not attached to the surface of the thermoplastic resin film 1, and further, do not remain on the surface of the thermoplastic resin film 1. After filling the conductive paste 5 in all the via holes 4, the conductive paste 5 put on the thermoplastic resin film 1 is removed from the surface thereof.

Furthermore, in the present embodiment, as shown in FIGS. 2C and 2D, a metal particle removing process is performed after filling the conductive paste 5 so as to reliably prevent the metal particles from remaining on the surface of the thermoplastic resin film 1. In the metal particle removing process, a squeegee 6a that is the same with the squeegee 6 used in filling the conductive paste 5 is used. Specifically, an end portion of the squeegee 6a is in close contact with the surface of the thermoplastic resin film 1, and the squeegee 6a is moved on the surface of the thermoplastic resin film 1. Thus, even if a small number of metal particles are attached to and remain on the surface of the thermoplastic resin film 1, the metal particles can be removed by using the squeegee 6a.

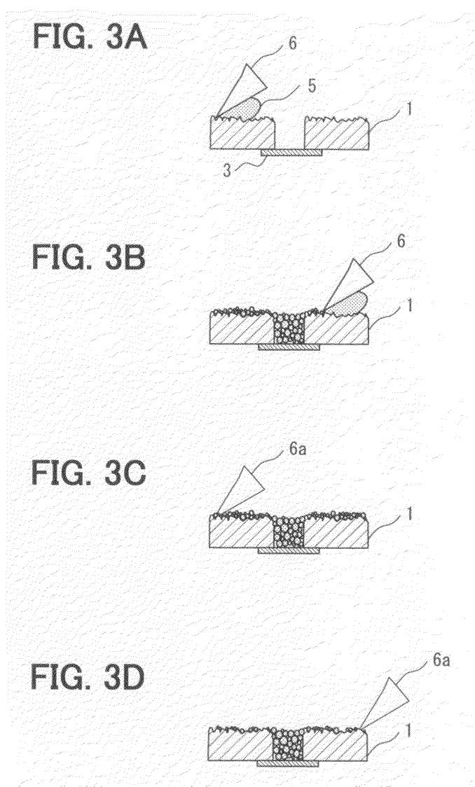

FIGS. 3A to 3D are cross-sectional views showing a state that the conductive paste filling process and the metal particle removing process are performed with respect to the thermoplastic resin film 1, to which the mirror finish is not performed.

Because mirror finish is not performed with respect to the thermoplastic resin film 1, the thermoplastic resin film 1 has a number of minute irregularities on the surface thereof. Because of a number of minute irregularities, the surface roughness (e.g., ten points average height Rz) of the thermoplastic resin film 1 becomes about 5 μm, for example. That is, the surface roughness of the thermoplastic resin film 1 is larger than the minimum particle diameter of the metal particles in the conductive paste 5. Thus, when the conductive paste 5 is moved on the surface of the thermoplastic resin film 1, the metal particles in the conductive paste 5 are fitted in the minute irregularities, and thereby, a number of metal particles are attached to and remain on the surface of the thermoplastic resin film 1 in the conductive paste filling process, as shown in FIG. 3B. A number of metal particles are fitted in the minute irregularities on the surface of the thermoplastic resin film 1. Thus, the metal particles cannot be removed from the surface of the thermoplastic resin film 1 even when the metal particle removing process is performed, as shown in FIGS. 3C and 3D.

As is obvious from FIGS. 2A to 3D and the description thereof, in the present embodiment, the mirror finish is performed with respect to the thermoplastic resin film 1, and the surface roughness of the thermoplastic resin film 1 is smaller than the minimum particle diameter of the metal particles in the conductive paste 5. Thus, even when the conductive paste 5 is directly put on the thermoplastic resin film 1 and is moved on the surface of the thermoplastic resin film 1 by using the squeegee 6, the metal particles are not attached to and do not remain on the surface of the thermoplastic resin film 1. Further, the metal particle removing process is performed after filling the conductive paste 5, and thereby, the metal particles can be reliably prevented from being attached to and remaining on the thermoplastic resin film 1. Thus, as described below, occurrence of an unintended short circuit in the circuit pattern layer 10 in manufacturing a multilayer board 100 by stacking the thermoplastic resin films 1 can be prevented.

Next, as shown in FIG. 1E, the thermoplastic resin films 1, which are manufactured in the processes shown in FIGS. 1A to 1D, are stacked. The circuit pattern 3 is formed on one surface of each of the thermoplastic resin films 1, and the conductive paste 5 is filled in the via hole 4. A stacked body including the thermoplastic resin films 1 is pressurized from both upper and lower surfaces on heating under vacuum by using a vacuum heating pressing machine (not shown in the drawings). In the heating-pressurizing process, the stacked body is heated to 250° C. to 350° C. and is pressurized at a pressure of 1 MPa to 10 MPa, for example.

By performing the heating-pressurizing process, multiple thermoplastic resin films 1 are heat-sealed each other so that the thermoplastic resin films 1 are unified. The silver particles and the tin particles included in the conductive paste 5 in the via hole 4 are sintered, and the sintered particles are metal-bonded to the circuit patterns 3 located on both ends of the conductive paste 5. Specifically, the tin particles in the conductive paste 5 melt and alloy with the silver particles. Further, the tin constituent in the conductive paste 5 and the copper constituent in the copper foil configuring the circuit pattern 3 are solid-phase diffused each other, and a solid-phase diffusion layer is formed at the interface between the conductive paste 5 and the circuit pattern 3. Therefore, the multilayer board 100, in which the adjacent circuit patterns 3 are electrically interlayer-connected by the alloyed silver and tin particles, is formed.

The above embodiment can be changed in various ways without departing from the scope of the invention.

Although the thermoplastic resin film 1 is used in the above embodiment, a substrate in which at least a surface is made of thermoplastic resin may be used.

For example, in the above embodiment, a thermoplastic resin film made of 85% to 15% by weight of polyetheretherketone resin and 15% to 85% by weight of polyetherimide resin is used for the resin film 1. However, the resin film 1 is not limited thereto. A film made by filling nonconductive filler in polyetheretherketone resin and polyetherimide resin, polyetheretherketone, polyetherimide, a liquid crystal film or the like may be used for the resin film.

In the above embodiment, the mirror finish is performed with respect to the thermoplastic resin film 1 after the metal layer 2 is attached to the thermoplastic resin film 1. However, the metal layer 2 may be attached to the thermoplastic resin film 1 after performing the mirror finish.

Further, in the above embodiment, the mirror finish is performed with respect to the thermoplastic resin film 1 by the heat-press with the use of the mirror-finished metal plate. However, the mirror finish may be performed by mirror-polishing the thermoplastic resin film 1, for example.

Moreover, in the above embodiment, the conductive paste 5 is filled in the via hole 4 having the bottom corresponding to the circuit pattern 3. However, a through-hole may be formed in the thermoplastic resin film 1 before forming the circuit pattern 3, and the conductive paste 5 may be filled with the bottom surface of the through-hole covered by a support plate.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A method for filling a conductive paste including metal particles in a via hole formed in a substrate having a surface made of thermoplastic resin, comprising:
performing mirror finish with respect to the surface of the substrate such that surface roughness of the substrate is smaller than a minimum particle diameter of the metal particles;
putting the conductive paste directly on the surface of the substrate after the performing the mirror finish; and
filling the conductive paste in the via hole by moving the conductive paste on the surface of the substrate with a squeegee having an end portion configured to be in close contact with the surface of the substrate.

2. The method according to claim 1, further comprising:
removing the metal particles remaining on the surface of the substrate by moving a contact member configured to be in contact with the surface of the substrate after the filling the conductive paste.

3. The method according to claim 1, wherein
the substrate is heat-pressed by using a mirror-finished metal plate in the performing the mirror finish.

4. The method according to claim 1, wherein
the substrate is mirror-polished in the performing the mirror finish.

5. The method according to claim 1, wherein
the surface roughness of the substrate is smaller than 1 μm when determined by ten points average height.

6. The method according to claim 1, wherein
the metal particles in the conductive paste are coated with a dispersing agent so as to prevent the metal particles from aggregating, and
particle diameters of the metal particles coated with the dispersing agent are larger than the surface roughness of the substrate.

7. A method for manufacturing a multilayer board, comprising:
stacking a plurality of the substrates, in each of which the conductive paste is filled in the via hole, according to claim 1, and a plurality of wiring layers, each of which is patterned into a desired shape, each other;
heat-pressing a stacked body including the substrates and the wiring layers;
sintering the metal particles in the conductive paste; and
heat-sealing the substrates via the wiring layers.
